(19) United States
(12) Patent Application Publication
(10) Pub. No.: US 2014/0023833 A1
(43) Pub. Date: Jan. 23, 2014

(54) TWO-LAYER TAPE AND JOINT SYSTEM FOR EXTERIOR BUILDING PANELS

(71) Applicant: Sanford Lloyd Futterman, Lakeway, TX (US)

(72) Inventor: Sanford Lloyd Futterman, Lakeway, TX (US)

(21) Appl. No.: 13/554,690

(22) Filed: Jul. 20, 2012

(51) Int. Cl. B32B 7/02; B32B 37/12

(52) U.S. Cl. 428/190; 156/71

(57) ABSTRACT

An improved two-layer tape for covering the joint between exterior building panels includes a single, semi-rigid, polymer composite foundation tape a plurality of perforations formed therethrough and a flexible, resilient two-component mesh finish tape adhered to the foundation tape in substantially parallel relation along their lengths. The mesh finish tape, which is a two-component reinforced strand mesh having a width greater than the width of the foundation tape, has openings formed therethrough such that when said two-layer tape is bedded in adhesive covering the joint between adjacent exterior building panels, the adhesive will pass through the plurality of perforations in the polymer composite foundation tape and the openings in the mesh finish tape. The two-layer tape can be incorporated in a two-layer tape core joint treatment system and employed in a method of covering the joint.

### BACKGROUND OF THE INVENTION

The present invention relates to sealing the joints of exterior building panels fastened to building frames to allow for the application of paint, a synthetic stucco finish or other coatings and covering on the exterior building panels.

Stucco finishes are an example of an exterior finish that has been used since ancient times. Still widely used throughout the world, stucco exterior finishes are one of the most common ways of finishing exteriors of both residences and commercial buildings. Like interior wall plaster, stucco has traditionally been applied on exterior surfaces as a multiple-layer process, sometimes including one or two, but more commonly three coats. Whether applied directly to a masonry substrate or onto wood with a metal lath, the process of applying stucco includes the step of applying a first “scratch” or “pricking-up” coat, followed by a second coat, sometimes referred to as a “floating” or “brown” coat, followed finally by the “finishing” coat. Up until the late-nineteenth century, the first and the second coats were of much the same composition, generally including lime, Portland cement, sand, perhaps clay and one or more other natural additives. Straw or animal hair was usually added to the first coat as a binder. The third, or finishing coat, consisted primarily of a very fine mesh grade of lime and sand, and sometimes a color pigment.

Although traditional stucco finishes have been used on building exteriors for quite some time, traditional stucco finishes have their limitations. Those limitations include porosity, rigidity, freeze/thaw fractures, fungal and mildew formation, cracking, complexity of installation, high maintenance and the requirement for a specialized skilled labor pool to properly apply the stucco finish so that it will be attractive and withstand the effects of weather.

Because modern synthetic stucco finishes are watertight, any water that remains trapped behind these modern synthetic stucco finishes does not readily evaporate. The trapped water behind the stucco finish can then soak into the substrata and framing of the building. The water that soaks into the substrata and framing often causes severe damage to the building without any signs of damage appearing on the exterior of the building. These problems can exist regardless of the age of the building or the quality of construction. Another problem leading to severe damage is insulation cladding. Specifically, insulation cladding is unforgiving for water penetration or condensation. Moreover, the durability of the cladding itself is prone to penetration by abrasion, birds, insects and airborne debris.

Although modern synthetic stucco finishes are attractive and long lasting, their usefulness is compromised by the integrity of the foundation to which it is applied. It has been found that one of the most durable foundations for a direct applied synthetic stucco finish is formed by either engineered treated wood panels, cement panels or fiber cement panels affixed either to the exterior sheathing or directly to the building frame.

The relatively recent introduction of engineered treated wood panels, cement panels, and fiber-cement panels, available in four foot widths by various lengths and thickness, has provided an opportunity to replace prior art stucco systems with a preformed exterior wall panel that can be installed like wood paneling or interior drywall panels. However, just like interior drywall panels, exterior building panels, when installed, have seams or joints between each panel that must be filled so that a smooth exterior finish may be applied.

To create a pleasing and uniform appearance for the exterior of a building, the outline of each wall panel should be invisible. For interior drywall panels, hiding the outline of each panel is achieved by tapering the edges of the panels so that when the drywall panels abut one another, the tapered edges provided a channel suitable for the use of tape and drywall compound (“mud”) to hide the resulting seams. The process of first taping and then placing mud over the tape creates a smooth transition between panels. Unfortunately, unlike interior drywall panels with their tapered edges, exterior building panels typically lack tapered edges and do not form a channel which is easily filled and masked. Hence, when exterior building panels are placed along side one other on the exterior of a building, a butt-joint with square edges is created. This butt-joint between the exterior building panels is difficult to visually disguise. In addition, the edges of each wall panel are subject to the stresses of building movement, temperature changes and other environmental factors. Accordingly, the foregoing factors must be considered when finishing an exterior wall so that no seams or joints between exterior building panels are visible.

One prior art solution, described in U.S. Pat. No. 6,516,580, teaches simply filling the gaps between exterior fiber cement panels with a polyurethane caulk. The polyurethane caulk is then covered with a 3-inch wide, peel-and-stick butyl-rubber tape having a fabric backing. This butyl-rubber tape and the rest of the panel is then coated with an exterior synthetic stucco finish coat. This solution has proven to be unsatisfactory because it overlooks the problems of out-gassing from the polyurethane caulk. Specifically, if the polyurethane caulk isn't fully cured due to time or climate constraints and is then covered by a non-permeable butyl rubber tape, the emission of gas from the polyurethane caulk causes blisters or ridges to form as the trapped gas tries to escape (out gas) from the polyurethane caulk. In addition, there is also a tendency for the butyl-rubber tape to “blister” if any air becomes trapped while handling and applying the butyl-rubber tape to the panel. Furthermore, the butyl-rubber tape is extremely tacky and has a tendency to stick to itself during application, creating a tenting effect that bulges outwardly from the butt-joint between the exterior wall of the fiber cement panel. Moreover, peel-and-stick tapes have a tendency to not stick well in cold or freezing temperatures as well as to suffer from “edge creep,” causing visible cracks to telegraph through to the stucco finish outlining the edges of the peel-and-stick tape.

The prior art approach of placing butyl-rubber tape over a polyurethane caulk overlooks the problem presented by a butt-joint between exterior fiber cement panels. By sealing the polyurethane caulk with a butyl-rubber tape, an elevation is created at the seams between the fiber cement panels. This elevation accentuates, rather than disguises, the outline of the panels. Flexibility at the butt-joint between the fiber cement panels is then compromised. To address the problem of accentuating rather than hiding panel outlines, applicators have attempted to place multiple layers of stucco over the exterior fiber cement panels. These multiple layers of stucco increase the material and labor cost. Moreover, any irregularities still evident after the stucco finish is applied will be very difficult, if not impossible, to hide.

Another prior art patent, U.S. Pat. No. 7,159,368, also describes the use of an elastomeric joint tape made with an elastomeric backing material, with the option of an optional release liner laminated to the adhesive.

Further research revealed the potential for hairline cracks at joints and seams given the issues of building settlement, stud movement, incorrect panel nailing and attachment, and other problematic construction practices. Upon further study, it was also determined that the over-application of ceramic spackle such as the Fill-N-Build product marketed by Global Coatings, Inc. at panel field joints could also contribute to hairline cracking. Moreover, the use of a reinforced joint tape along with a mastic such as the AcraCream product marketed by Global Coatings, Inc. as the sole factor to seal, waterproof and manage joint movement could be improved. Given the soft flexible nature of the mastic, the joint tape and a primer such as the ColorFlex product marketed by Global Coatings, Inc., tethered by direct interface to relatively hard synthetic stucco finish such as the Carrara product marketed by Global Coatings, Inc., the potential for hairline cracks in the synthetic stucco finish would be enhanced by the flexing of the relatively softer and more flexible joint treatment components.

In view of the issues of building envelope movement as well as freeze/thaw cycles associated with weathering, a joint treatment system providing a basis for a non-cracking finish and stucco system usable on various types of exterior building panels was disclosed by the inventor of the present application in U.S. Pat. No. 7,836,652. An improved two-layer tape and dual-tape core joint treatment system providing even more robust and forgiving performance in the presence of building envelope movement is disclosed herein.

### BRIEF SUMMARY

In some embodiments, an improved two-layer tape for covering the joint between exterior building panels includes a single, semi-rigid, polymer composite foundation tape a plurality of perforations formed therethrough and a flexible, resilient mesh finish tape adhered to the foundation tape in substantially parallel relation along their lengths. The mesh finish tape, which is a two-component reinforced strand mesh having a width greater than the width of the foundation tape, has openings formed therethrough such that when said two-layer tape is bedded in adhesive covering the joint between adjacent exterior building panels, the adhesive will pass through the plurality of perforations in the polymer composite foundation tape and the openings in the mesh finish tape. The two-layer tape can be incorporated in a two-layer tape core joint treatment system and employed in a method of covering the joint.

In some embodiments, an improved two-layer tape for covering the joint between exterior building panels includes a single, semi-rigid, polymer composite foundation tape, which includes a polymer base having a wall-facing surface to which a floc providing a surface texture is adhered or smooth texture-free surface and a tape-facing surface free from floc. The foundation tape has a plurality of perforations formed therethrough. The two-layer tape further includes a flexible, resilient mesh finish tape adhered to the tape-facing surface of the foundation tape in substantially parallel relation. The finish tape has a width greater than the width of the foundation tape, and the mesh finish tape has openings formed therethrough such that when said two-layer tape is bedded in adhesive covering the joint between adjacent exterior building panels, the adhesive passes through the plurality of perforations in the polymer composite foundation tape and openings in the mesh finish tape to secure the two-layer tape to the exterior building panels. The two-layer tape can be incorporated in a two-layer tape core joint treatment system and employed in a method of covering the joint.

### BRIEF DESCRIPTION OF THE SEVERAL VIEWS OF THE DRAWINGS

FIG. 1 is a perspective view of a prior art dual-core tape joint treatment system by the inventor of the present application;

FIGS. 2A-2B are section views of the installation of a prior art two-layer tape before and after bedding the dual-core tape in a bedding layer of mastic by the inventor of the present application;

FIG. 3 is depicted an illustrative embodiment of an improved two-layer tape and a method of its manufacture;

FIGS. 4A-4B are section views of a first illustrative embodiment of an improved dual-core tape joint treatment system illustrating the bedding of an improved two-layer tape in a bedding layer of mastic; and

FIG. 5 is a section view of a second illustrative embodiment of an improved dual-core tape joint treatment system having beveled building panels.

### DETAILED DESCRIPTION

The present disclosure provides for an improved two-layer tape, panelized wall systems constructed with an improved dual-tape-core joint treatment system, and methods of their use and manufacture. The dual-tape-core joint treatment technology disclosed herein can be constructed using two individual tapes applied in sequence in the field, or may alternatively be constructed utilizing an improved two-layer tape with the two individual tapes manufactured in duality for improved ease of application in the field. The improved dual-tape-core joint treatment system described herein can include various system components including those described below.

Joint. The term “seam” or “joint” or “butt joint” as used herein refers both to a structure formed by the edges or corners of adjacent building panels and to a system of components used to fill or cover this structure. A joint, butt joint or seam is formed by two adjacent panels that may or may not have a gap between them, i.e., butted together or with a gap between them (joint or seam).

Moisture Barrier. Moisture barriers are used in certain embodiments of the disclosed panelized wall systems. Any type of moisture barrier, also called water barriers and weather-resistive barriers, known in the art may be used, for example, asphalt paper, polyethylene-based sheeting, reinforced plastic sheeting, or foam insulation panels. The moisture barrier, if present, is installed between the frame and the building panels.

Frame. As used herein, a frame is defined as any set of one or more structural members capable of supporting the disclosed panelized wall system. Preferred frames are wood or metal frames. Preferably, the vertical members of the frame are spaced about 16″ apart, up to about 24″ apart or more, and optionally wrapped in a moisture barrier. Another preferred frame is a shear wall, a frame to which shear panels, typically plywood or oriented strand board (OSB) panels, are attached for reinforcement. Other examples of a suitable frame include a tilt-up wall, or a previously finished wall, such as wall finished with a cladding. Preferably, the building panels are positioned on the frame with the edges of adjacent panels sharing a common framing member, for example, a stud. In some embodiments, the panels are positioned with a gap of predetermined width between adjacent panels, with the gap falling directly over a framing member. In another embodiment, the panels are installed without gaps, i.e., butted edge-to-edge. In embodiments with gaps between adjacent panels, the width of the gap is preferably from about 1/16″ to about ⅛″, allowing for building and panel movement and for shrinkage and expansion of the building panels. In many installations, the building panels are preferably installed level and plumb.

The building panels may be attached to the frame by any means known in the art. Mechanical means include nails, screws, staples, nuts and bolts, clips, and the like. The panels may also be fastened to the frame with chemical means, for example, with an adhesive or a tape. A predetermined pattern of fasteners is typically used to fasten the building panels to the frame. Preferred fasteners are screws and nails.

Building Panels. The building panels of the present application can be made from substrates suitable for interior or exterior construction. The panels may be flat or embossed, and may also have textured surfaces and/or tapered edges. The substrate may be inorganic, organic, or a combination thereof. Treated engineered wood panels are preferred especially for residential construction, such as the SmartSide® panels and trim marketed by Louisiana Pacific. Other suitable building panels include fiber cement panels such as the WeatherBoard panels marketed by CertainTeed or the Hardie Panel marketed by James Hardie that can be either untreated or pretreated with a coating to modify water absorption through the panel face. Other suitable substrates may include glass mat reinforced cement boards, glass mat reinforced gypsum boards, and materials such as the Dens-Glass Gold panel marketed by Georgia Pacific and the Aquatough panel marketed by United States Gypsum. It will be appreciated, however, that the disclosed method may be applicable to other fiber-reinforced inorganic substrates as well as other substrates, including but not limited to aluminum, cement composites such as scrim board, wood, plywood, oriented strand board (OSB), wood composites, gypsum boards, and plastics such as polymer foam (e.g., expanded polystyrene) composite panels.

The components of the disclosed embodiments of the invention have been selected to work best with the treated engineered wood SmartSide brand marketed by Louisiana Pacific, that unlike fiber cement panels, is approved for single wall construction and can easily accommodate a tapered edge. It will be appreciated that similar components can be selected to achieve the same performance when used with building panels composed of other substrates.

Adhesives. As described hereinafter, a base adhesive layer is disposed between the building panel and the foundation tape. The base adhesive layer preferably has a thickness that allows it to slip and distribute the movement of the building panels to the foundation and finish tapes, preventing cracking of the finish coat. The dual-tape-core joint treatment system anchors the edges of the foundation tape by the finish tape to the building panels, preventing the edges of the foundation tape from slipping. Thicker and softer adhesive layers generally slip more easily, although the minimum thickness required to provide the desired slip characteristics will vary for each different adhesive. A preferred base adhesive layer thickness is from 1 mil to 40 mils. A thinner adhesive layer is easier for the finish to hide, however, and may be preferred to provide a superior finish. The adhesive may be deposited in a single pass or several passes and may include a single adhesive or multiple adhesives, for example, a dual adhesive system.

The adhesive, may be, for example, an acrylic flexible joint compound. However, as will be hereinafter assumed, the dual-tape-core joint treatment system disclosed herein preferably employs an elastomeric mastic as the adhesive. The elastomeric mastic is preferably characterized by an elongation greater than about 20%. The mastic may be a pressure-sensitive or a non-pressure-sensitive mastic, for example, one that is applied by putty knife. The latter class of mastic is particularly preferred. These mastics are normally tacky at room temperature and adhere to a surface by application of light finger pressure. In another embodiment, a hot-melt mastic may be preferred.

The mastic may include water-based, solvent-based, and 100% solid-based mastics. Preferred mastics include one-component and two-component compositions. The mastic may be based on, for example, general compositions of polyacrylate, polyvinyl ether, rubber (e.g., natural rubber), isoprene, polychloroprene, butyl rubber, neoprene rubber, ethylene propylene diene rubber (EPDM), polyisobutylene, butadiene-acrylonitrile polymer, thermoplastic elastomers, styrene-butadiene polymer, poly-alpha-olefin, amorphous polyolefin, silicone, ethylene-containing copolymer (e.g., ethylene vinyl acetate, ethylene ethyl acrylate, ethylene n-butyl acrylate, and ethylene methyl acrylate), polyurethane, polyamide, epoxy, polyvinylpyrrolidone and polyvinylpyrrolidone copolymers, polyesters, and mixtures or copolymers thereof. The mastic may also contain additives or modifiers, for example, tackifiers, plasticizers, fillers, antioxidants, stabilizers, pigments, curatives, cross linkers, solvents, etc. One preferred embodiment is a mastic that is a water-based high solids elastomeric acrylic sealant with typical properties of 66% solids by volume, 325 psi tensile strength and 150-200% elongation with a mixture by weight of acrylic polymer 54%, calcium carbonate 30%, water 5%, isobutane 4%, titanium dioxide 2%, and petroleum derivatives 2%. In another preferred embodiment, a mastic has between 20-50% elongation.

It is expressly contemplated that the adhesive can be applied in either a continuous manner, such as a uniform layer, or in a discontinuous manner, such as strips or bands, dots, or another patterned or random arrangement of discrete adhesive portions. The thickness of the adhesive is controlled according to the requirements of the application.

Foundation Tape. The foundation tape is preferably made from plastic, and more particularly, from a polymer such as polyvinyl-chloride (PVC) that is semi-rigid. In addition to PVC, other semi-rigid polymers that are satisfactory include, for example, polypropylene, polyethylene, nylon/PVC, and other polymeric materials and combinations. One preferred foundation tape is made from a PVC fiber composition material, for example, the Crack-Tape composition tape marketed by Strait-Flex, Inc. The ability of the foundation tape to adhere to adhesives (e.g., mastics) is enhanced by gluing fibers, known as floc, to the inward, wall-facing surface of the foundation tape to impart a surface texture. The fibers can be, for example, nylon, rayon, Dacron, polyester, cotton, cellulose, or other similar fibers or combinations of fibers. In one embodiment, preferred fibers are formed of cotton, wool or nylon or combinations thereof. Nylon fibers or other water impervious fibers can be used where a waterproof application is required or desired. Further mechanical bond adherence to the adhesive is developed through the use of die cut perforations in the foundation tape that allow the adhesive to ooze through and encapsulate the foundation tape. The perforations also allow for the escape of air pockets that tend to form during installation and also provide a visual cue as to whether sufficient adhesive has been applied under the tape. In various embodiments, the perforations can be uniformly distributed throughout the foundation tape or alternatively can be allocated along the perimeter. The perforations may be circular, oblong, or angular with the number and size of the perforations such that they do not compromise the structural or semi-rigid character of the foundation tape. Preferably, the foundation tape can be 8-40 mils, preferably 10-20 mils in thickness to provide sufficient rigidity to bridge gaps in building panel installation while having enough flexibility to be packaged in rolls. The foundation tape is also preferably thin enough to minimize the weight of the foundation tape and the amount of mastic needed to apply it. For flat wall applications, the foundation tape is preferably flat and lacks any longitudinal or embossed line of weakness to facilitate bending or folding.

Finish Tape. The finish tape is preferably a fabric, film or mesh/mat to which the adhesive and coating components of the disclosed panelized wall systems adhere, e.g., the mastic, ceramic spackle, primer coat and textured finish coating, particularly cement stucco coatings and latex-based cement-free texture coatings. Of these tape materials, a mesh is preferred. Preferred meshes are polyester, polypropylene, polyethylene, polyamide, vinyl, cellulose, cotton, rayon, glass fiber, or combination of two or more of these materials. For example, the mesh may be a vinyl-coated polyester mesh. The mesh may also be, for example, an alkaline-resistant fiberglass-coated latex mesh. Preferably, the finish tape material has a selected moisture absorption characteristic that provides a monolithic appearance to the finish coat. One example of a prior art finish tape material is made from a nonwoven polyester mesh, for example, Bamilex reinforced spunbonded polyester mat tape marketed by Saint-Gobain, which is constructed of spunbonded nonwoven polyester web reinforced with 5×5 yarns per inch mesh of 500 denier tenacity polyester with an average net weight of 2.1 ounces per square yard and 4-10 mils in thickness. In some embodiments in which greater ability to disguise the edges of the foundation tape are desired, a finish tape of approximately 10-40 mils, and more particularly, about 10-20 mils is preferred.

The main function of the finish tape is to seal and anchor the edges of the foundation tape and to enable the mastic to feather past the foundation tape and form a flat rubber-gasket like joint that is invisible beneath the textured finish coat. Another function of the finish tape is to follow the shrinkage of the mastic as it cures, forming a seal over the foundation tape, especially over the edges of the foundation tape. A potential for edge creep by the foundation tape is ameliorated by the overlapping and anchoring of the edges of the foundation tape with the larger width finish tape thereby preventing cracking of the stucco or finish coat applied over the dual-tape-core joint treatment. A preferred width of the finish tape is from about 1″ to about 12″. In the construction field, a cost effective width of finish tape is from 2″ to about 6″, depending on the width of the foundation tape. The finish tape is preferably wider than the foundation tape. For instance, if the foundation tape is 2″ to 2.25″ wide, an ideal width for the finish tape is about 4″. This about 2:1 width ratio of finish tape to foundation tape is preferred to accommodate alignment error in the field. Given that the foundation tape is covered and ideally hidden by mastic, completely covering the foundation tape with the finish tape may be problematic if the finish tape isn't evenly centered over the foundation tape. Hence, the finish tape is preferably significantly wider than the foundation tape to accommodate a varying degree of placement error when contractors are trying to align the finish tape over the center of the foundation tape. Of course, such alignment error is eliminated in embodiments in which the foundation tape and finish tape are prelaminated at manufacture.

In embodiments in which the finish tape is a mesh, such as a vinyl-coated polyester mesh, the finish tape (like the foundation tape) preferably has perforations or openings formed therethrough to allow the mastic applied beneath and over the tapes to flow through and encapsulate both the foundation tape and finish tape. In this manner, edge creep can be further ameliorated. The openings are preferably uniformly distributed throughout the finish tape including in the portion overlaying the foundation tape and may be of any number, shape or size as long as they do not compromise the structural integrity of the finish tape. The finish tape is preferably resilient, has a high tensile strength, and is significantly more flexible than the foundation tape.

Ceramic Spackle. Certain embodiments of the disclosed dual-tape-core joint treatment system include the use of an exterior ceramic spackle applied over a mastic that encapsulates a mesh finish tape. Ceramic spackle can be applied, for example, on any embossed building panel or trim edges or other edge profile defined with corner beads or trim on building panels. The ceramic spackle fills any depressions in the corner bead areas, providing a smooth surface for the textured finish coat. The ceramic spackle, unlike the mastic, does not contain elastomeric properties but rather is designed to provide a surface that is sandable, non-shrinking, high-fill and easily spreadable that is also weather resistant, once dry and cured. The ceramic spackle is preferably a mixture that includes a polymer binder, one or more inorganic fillers, thickeners, pigments, and inorganic binders.

Polymer latex emulsions such as acrylic emulsions are well known in the art and are suitable as the elastomeric polymer binder. Other suitable polymer binders include re-dispersible powdered acrylics, styrene-acrylics and polyurethanes.

Inorganic binders can be used in the ceramic filler material to provide hardness and scratch resistance. One example of a suitable inorganic binder is soda lime borosilicate glass, calcium carbonate, kaolin clay, aluminosilicate, and other silicate minerals are examples of suitable inorganic fillers, and are well known in the art. The inorganic filler may also be a low-density expanded mineral such as perlite. Hollow aluminosilicate or polymeric microspheres are examples of inorganic fillers that both modify the density of the joint filler and control the expansion and contraction characteristics.

Suitable thickeners are well known in the art and include cellulose ethers, vegetable gums, clays, and synthetic polymers such as ammonium salts of acrylic polymers. Pigments may be white, for example titanium dioxide, kaolin clay, or calcium carbonate, or colored, for example iron oxides. Pigments suitable for coloring the ceramic spackle are well known in the art.

The ceramic spackle may be applied over the mastic and the finish tape by any method known to the art, for example by using a putty knife or trowel. It has been described in prior art that a ceramic joint filler, may be applied in one or more thin layers in order to minimize the visibility of the joint. However, it has been discovered that the ceramic joint filler is subject to cracking that will telegraph through to the textured finish coat. This is detrimental to the goal of creating a panelized wall system utilizing a joint tape that resists cracking.

In one embodiment, however, the ceramic spackle is especially useful to smooth and level corner bead trim on outside corners, columns and arches whose panel edges are fitted with corner beads. In another embodiment, pre-treating the corner bead wings with mastic and finish tape, provides a rubber gasket-like sealant to prevent moisture from migrating through the corner bead should the ceramic spackle crack become damaged.

The thickness of the ceramic spackle application depends on the depth of the corner beads and other edge features on the panels. Once applied, the ceramic spackle is typically allowed to cure (harden) for several hours, depending on temperature and relative humidity. After curing, the ceramic spackle, as an option, may be smoothed very fine by sanding. A preferred ceramic spackle contains by weight acrylic copolymer emulsion (30%), hydrated aluminum silicate mineral (19.5%), soda lime borosilicate glass (10%), kaolin clay (8%), titanium dioxide (4%), and ammonium salt of acrylic polymer (1%).

Primer. A primer coating can be applied to the entire wall assembly using a paint roller or airless spray. After being allowed to dry 1 to 2 hours, the primer coating provides a surface with uniform absorption properties and uniform color that matches the textured stucco finish coat. The primer coating is typically a high quality, water-based acrylic-epoxy coating designed to enhance bonding to multiple substrates and increase its abrasion resistance. A special spherical silica sand is suspended in the textured version to provide a fine uniform nonskid finish that enhances the trowel application of texture top coats on smooth, slick vertical substrates with the following properties: 52% solids by volume, >200° F. (93° C.) flash point, 30 minutes to touch dry time and 1-2 hours for re-coat or application of a textured finish coat. Another primer that may be employed is a high performance elastomeric acrylic with the following properties: 55% solids by volume, 150 psi tensile strength at 75° F. and 400 psi at 0° F.; 300% elongation at 75° F. and 400% elongation at 0° F. The elastomeric acrylic primer effectively covers existing hairline cracks and bridges hairline cracking caused by further building movement. Other known elastomeric or non-elastomeric primers, finish coats, water based or solvent are well known in the art and generally contain a polymer binder, inorganic filler, water and pigments, and are also suitable.

Stucco Finish Coating. One possible finish that may be applied is a textured finish simulating stucco, selected for its water resistance and flexibility. This type of finish is commonly referred to as “synthetic stucco” or simply “stucco.” Such finishes are well known in the art and are generally contain a polymer binder, inorganic filler, water, and pigments. Texture coatings are generally applied with a hopper or trowel in one or more coats. Various exterior textures finishes can be applied to the exterior building panel depending on the aggregate mix and the application technique. If synthetic stucco is used, the synthetic stucco cures to a stone-like veneer providing added durability to the underlying panel. Furthermore, the system and method of the present invention provides independent elastomeric properties in the underlying acrylic primer and the components in the dual-tape-core joint treatment system to synergistically work together to provide enhanced system flexibility and durability.

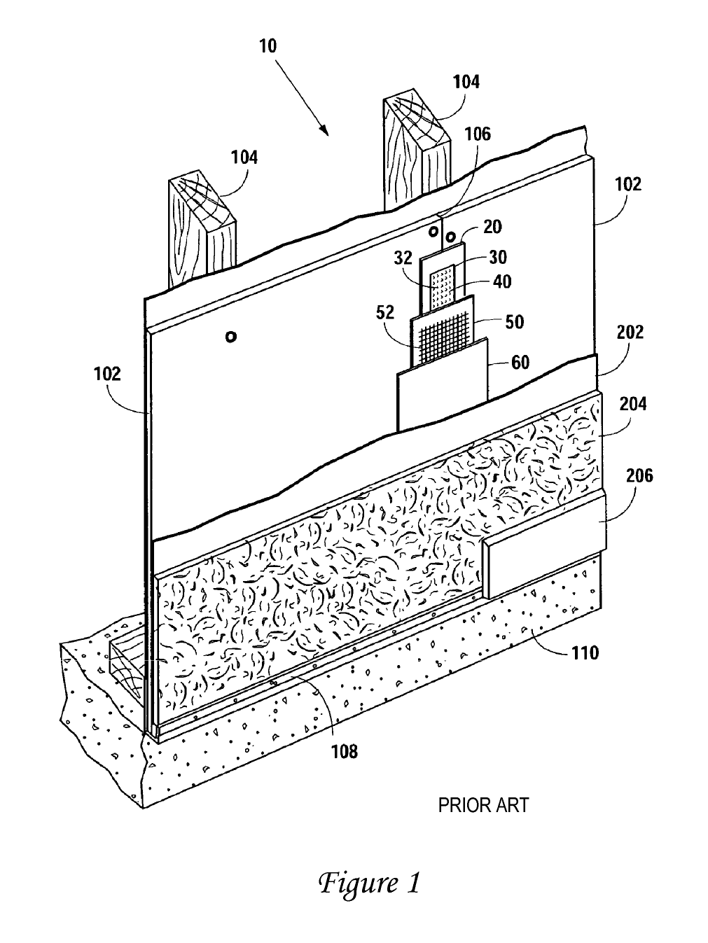

Referring now to FIG. 1, there is depicted an example of a prior art dual-core tape joint treatment system 10 as disclosed by the inventor hereof in U.S. Pat. No. 7,836,652. In prior art dual-core tape joint treatment system 10, exterior building panels 102 (e.g., the SmartSide engineered wood panels marketed by Louisiana Pacific or other previously described building panels) are first secured to the building frame 104 per the manufacturer's guidelines. The adjacent edges of building panels 102 are butted together or lightly gapped to form a joint 106 there between.

An optional weep screed termination 108 installed over the foundation 110 at the base of each building panel 102 provides a level line to aid installation, a drainage plane and corner bead-like protection. Once exterior building panels 102 are mounted to building frame 104, mastic 20 is applied, for example, with a 4-6 inch putty knife, over the center of seam 106 to fill seam 106. A perforated polymer-fiber composite foundation tape 30 is then bedded into the wet mastic 20. A first cover coat of mastic 40 is then applied, for example, with a larger 6-9 inch putty knife, over foundation tape 30 to prepare a mastic bed for the application of finish tape 50, such as a mesh having perforations 52 therethrough. Finish tape 50 is then centered over and overlapping narrower foundation tape 30 so as to prevent edge creep or hairline cracking from telegraphing through the stucco finish coat. Moreover, the larger width of the finish tape 50 also provides a platform to taper the disclosed dual-tape-core joint treatment system 10. Floating a second cover coat 60 of the mastic, for example, from 9 to 12 inches on both sides of the joint or seam, assists in helping level the dual-tape-core joint treatment and present a flatter appearance for the overall wall profile.

Once the second cover coat of mastic 60 is dry, a ceramic spackle is then applied, and the corner beads, columns, arches and other architectural panel details are floated and feathered. As the ceramic spackle is formulated with acrylic resins, the ceramic spackle is provided a strong bond and cures with the underlying acrylic flexible joint compound. When dry, the ceramic spackle may be sanded if required, providing an extremely smooth, flat surface for the application of the acrylic elastomeric coating that follows.

A scratch coat 202, such as an acrylic-based coating, roller applied, color matching scratch coat, is then preferably applied over the entire exterior building panels 102, corner beads, and the dual-tape-core treated joints. An acrylic based coating with spherical sand suspended, provides a non-skid finish for a finish coat 204 to grab, much like the function of a cement-based scratch coat. In the alternative, an elastomeric coating, which can also be tinted the same color as the textured exterior finish topcoat, can be spray-applied, rolled or brushed onto the exterior of the building.

A final textured or non-textured finish coat 204 is then applied onto the wall with a hopper gun or by troweling or rolling. Various exterior textures can then be applied to the previous scratch coat or elastomeric primer depending on the aggregate mix and the application technique. If synthetic stucco is used, the synthetic stucco cures to a stone-like veneer providing added durability to the exterior building panels. An optional trimband 206 may then be placed over the textured finish coat near the foundation 110.

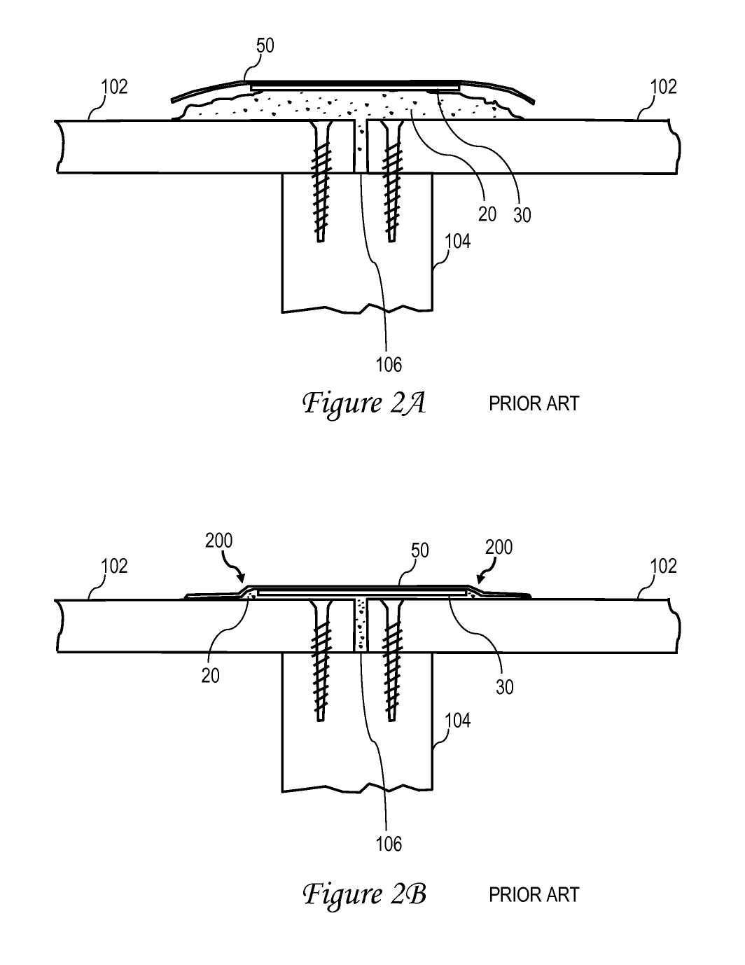

Referring now to FIGS. 2A-2B, vertical section views of the installation of a prior art from the inventor of the present application demonstrates a two-layer tape before and after bedding the two-layer tape in a bedding layer of mastic are depicted. For clarity, like reference numerals are utilized to identify features corresponding to those pictured in FIG. 1.

As shown in FIG. 2A, mastic 20 has been applied to joint 106 of building panels 102 to fill joint 106 and create a bedding layer for the conventional two-layer tape. In the depicted example, the conventional two-layer tape includes a foundation tape 30 manufactured in duality with a finish tape 50 comprising the Bamilex reinforced spunbonded polyester mat tape previously described. A length the two-layer tape, comprising foundation tape 30 finish tape 50, is then aligned over joint 106 and manually pressed into contact with wet mastic 20, causing the two-layer tape to adhere to the surface of mastic 20. As shown in FIG. 2A, finish tape 50 has a tendency to droop or slacken across its width and, if care is not taken by the installer, may at this time wrinkle or curl, particularly as various portions of finish tape 50 contact mastic 50, allowing the telegraphing of ridge lines from the edges of the foundation tape 200.

After the two-layer tape is temporarily adhered to the surface of mastic 20 as shown in FIG. 2A, the installer beds the two-layer tape in the bedding layer of mastic 20, typically by running a putty knife down the length of the two-layer tape from the top to the bottom of joint 106. As shown in FIG. 2B, bedding the two-layer tape forces a large quantity of the mastic 20 applied to the faces of building panels 102 from beneath the two-layer tape, and adheres both foundation tape 30 and finish tape 50 to the faces of building panels 102 with a small amount of residual mastic 20. A skilled installer will typically be able to achieve a fairly uniform layer of residual mastic 20 and eliminate most of the undesirable wrinkles or bubbles in finish tape 50. However, because of the extremely small pore size of the openings in the spunbonded polyester mat utilized for finish tape 50, investigation in the field has found that little, if any, of mastic 20 penetrates the two-layer tape in a typical installation. Further, the inherent slackness of the spunbonded polyester material causes steps 200 to form along the edges of foundation tape 30 as the two-layer tape is bedded. In general, the small surface discontinuity caused by steps 200 can be hidden at installation by appropriately feathering out cover coat 60 of mastic, as shown in FIG. 1 and described above.

Experience in the field has shown that a building envelope may be subject to a degree of variability and movement due to a number of factors, including temperature changes, wind loads, moisture penetration, soil or foundation shifting or settling, and the quality of original construction. Prior art dual-core tape joint treatment system 10 illustrated in FIGS. 1 and 2A-2B is sufficient to achieve acceptable results in most applications, particularly if care is taken to achieve a high quality of original construction (e.g., building frame 104 is straight and plumb, the manufacturer-recommended number of fasteners are utilized to secure building panels 102 to building frame 104, etc.). However, if the building envelope is subjected to significant movement, for example, due to poor original construction quality and/or other(s) of the factors noted above, steps 200 can become visible through finish coat 204 and can even form the locus of the formation of cracks in finish coat 204, despite the feathering of steps 200 with cover coat 60 at the time of construction.

In order to provide a solution appropriate for environments in which greater variability in the building envelope is experienced, an improved dual-tape-core joint system sufficient to accommodate the high stresses of significant movement in the building envelope was developed. The improved dual-tape-core joint system incorporates an improved two-layer tape as described further herein.

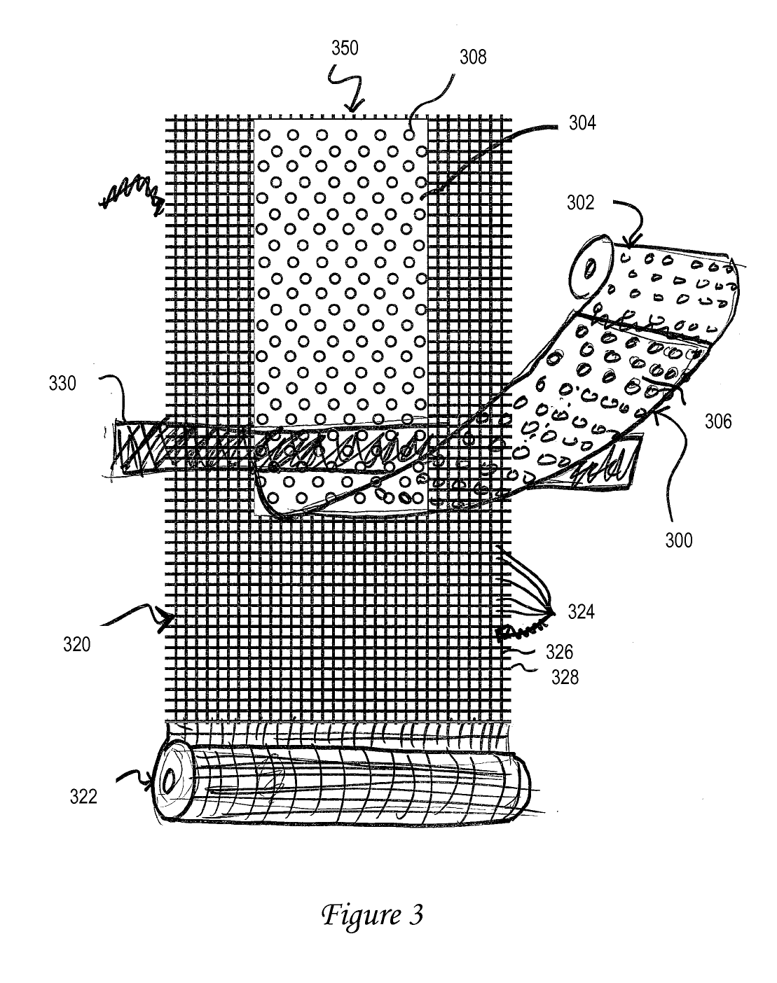

With reference now to FIG. 3, an illustrative embodiment of the improved two-layer tape and a method of its manufacture are illustrated. In the illustrative embodiment, foundation tape 300 is received, for example, in the form of a first roll 302. Foundation tape 300, which has an inward, wall-facing surface 304 and a tape-facing surface 306, is formed, in the illustrative embodiment, of a polymer base (e.g., PVC or one of the other semi-rigid polymers previously described) having floc adhered to only wall-facing surface 304, leaving tape-facing surface 306 free of any material or composition adhered to the polymer base. In other embodiments, wall-facing surface is also free from floc. Foundation tape 300 preferably has perforations 308 formed therethrough to permit adhesive to flow through and secure foundation tape 300 to the building panels.

In the illustrative embodiment, finish tape 320 is likewise received in a second roll 322. In the depicted embodiment, finish tape 320 is preferably formed of a two-component reinforced strand mesh defining unobstructed openings 324 between its warp 326 and woof 328. For example, finish tape 320 may be formed of 9×9 yarns per inch 1000 denier polyester that is vinyl-coated to obtain a resulting tape having a weight of 6.5 oz. per square yard and a thickness of approximately 15-30 mils, and more particularly, about 20 mils. Finish tape 320 preferably is resilient, has a high tensile strength, is water and rot resistant, and has greater flexibility than foundation tape 300. The reinforcement of the strands of finish tape 320 (e.g., the reinforcement of the base polyester fibers with the vinyl coating) imparts structure and tautness to the base polyester fibers, lessening the drape of finish tape 320 and yielding a more forgiving and stronger joint treatment system, as discussed further below.

During the manufacturing process, foundation tape 300 and finish tape 320 are fed from first and second rolls 302 and 322, respectively, through a laminator 330 that laminates foundation tape 300 and finish tape 320 to obtain a two-layer tape 350. Laminator 330 may utilize, for example, a hot melt material (e.g., ethylene-vinyl acetate (EVA) copolymers, polyolefins, polyamides, polyesters, polyurethanes, etc.) and/or heat treatment to bond tape-facing surface 306 of foundation tape 300 and finish tape 320. The absence of floc on tape-facing surface 306 of foundation tape 300 promotes a more secure and durable bond between foundation tape 300 and finish tape 320. Because two-layer tape 350 has perforations through foundation tape 300 and openings 324 in finish tape 320, the adhesive (e.g., mastic) utilized to cover the joints between the building panels can flow through, encapsulate, and secure both foundation tape 300 and finish tape 320 of two-layer tape 350.

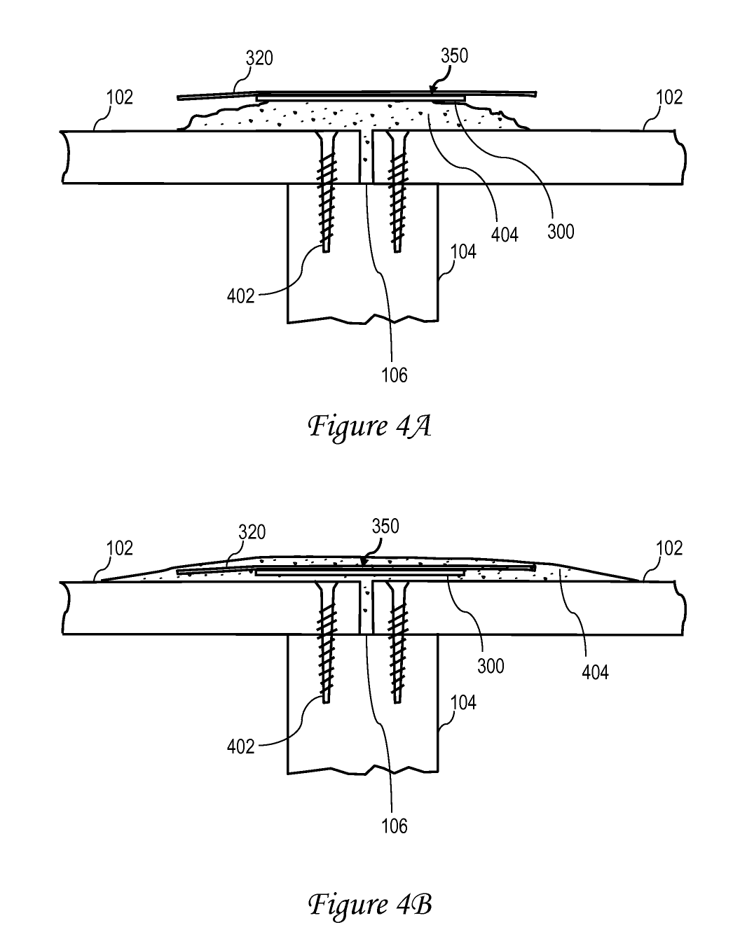

Referring now to FIGS. 4A-4B, section views are depicted of a first illustrative embodiment of a dual-core tape joint treatment system illustrating the bedding of the improved two-layer tape in a bedding layer of mastic. In the depicted embodiment, building panels 102, such as the SmartSide engineered wood panels previously described, are secured to the exterior of building frame 104, optionally after installation of a moisture barrier (not illustrated). Building panels 102, which can be butted together, but are preferably gapped to form a narrow (e.g., ⅛ inch) seam 106 therebetween, are secured to building frame 104 by fasteners, such as screws 402 or nails.

After building panels 102 are mounted to the building frame 104, a bedding adhesive layer, such as mastic 404, is applied (e.g., with a putty knife) to fill and/or cover seam 106. A length two-layer tape 350, comprising foundation tape 300 and finish tape 320, is then aligned over joint 106 and manually pressed into contact with wet mastic 404, causing two-layer tape 350 to adhere to the surface of mastic 302, as shown in FIG. 4A. Due to the reinforcement of the strands of the base material, finish tape 320, unlike prior art finish tape 50, does not significantly droop or slacken across its width and therefore does not tend to wrinkle or curl.

After two-layer tape 350 is temporarily adhered to the surface of mastic 404 as shown in FIG. 4A, the installer beds two-layer tape 350 in the bedding layer of mastic 404, for example, by running a putty knife down the length of two-layer tape 350 from the top to the bottom of joint 106. As shown in FIG. 4B, bedding two-layer tape 350 forces mastic through the perforations 308 in foundation tape 300 and the openings 324 in finish tape 320, thus surrounding and encapsulating two-layer tape 350 within mastic 404.

Encapsulating two-layer tape 350 within the bedding layer of mastic 404 in this manner has at least two consequences. First, two-layer tape 350 reinforces and strengthens mastic 404, much like a grid of rebar encased in a concrete foundation. Second, two-layer tape 350 is somewhat isolated from the movement of building panels 102 by mastic 404 rather than locked down to building panels 102 at the edges of finish tape 320 (as shown in FIG. 2B). As a result, the dual-core tape joint treatment system shown in FIGS. 4A-4B provides improved performance in building environments in which high stresses are exerted on the joints 106 between exterior building panels 102.

After the bedding layer of mastic 404 has cured, a second cover coat of mastic can be applied to feather the dual-tape-core joint treatment to achieve a relatively flat appearance for the overall wall profile. Thereafter, a ceramic spackle, scratch coat, primer coat, and/or a finish coat can be applied over the improved dual-core tape joint treatment system and building panels 102 as previously described.

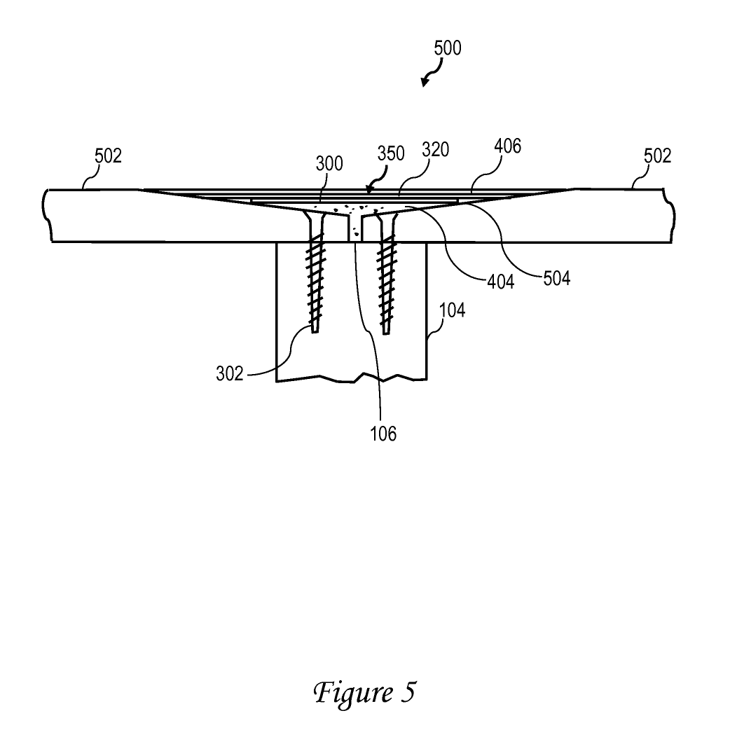

With reference now to FIG. 5, there illustrated a vertical section view of a second embodiment of an improved dual-core tape joint treatment system 500 including building panels having beveled edges. In the depicted embodiment, building panels 502, such as the SmartSide engineered wood panels previously described, are secured to the exterior of building frame 104, optionally after installation of a moisture barrier (not illustrated). Building panels 502, which can be butted together, but are preferably gapped to form a narrow (e.g., ⅛ inch) seam 106 therebetween, are secured to building frame 104 by fasteners, such as screws 302 or nails. As illustrated, building panels 502 preferably have bevels 504 along the edges adjacent seams 106 to promote a flat finished exterior profile of dual-core tape joint treatment system 500. Each pair of adjacent bevels 504 form a niche in the exterior wall of the building.

After building panels 102 are mounted to the building frame 104, a bedding adhesive layer, such as mastic 404, is applied (e.g., with a putty knife) to fill and/or cover seam 106. Two-layer tape 350 is bedded into and encapsulated by mastic 404, as previously described with reference to FIGS. 4A-4B. A thin second cover coat 406 of mastic can then be utilized to level the dual-tape-core joint treatment system 500 and to achieve a flat appearance for the overall wall profile. Thus, the use of beveled building panels 502 in combination with improved two-layer tape 350 enables a flat wall profile to be achieved in two passes, rather than three passes as described above with reference to the prior art system illustrated in FIG. 1. Thereafter, a ceramic spackle, scratch coat, primer coat, and/or a finish coat can be applied over dual-core tape joint treatment system 500 and building panels 502 as previously described.

As has been described, in some embodiments, a two-layer tape for covering the joint between exterior building panels includes a single, semi-rigid, polymer composite foundation tape a plurality of perforations formed therethrough and a flexible, resilient mesh finish tape adhered to the foundation tape in substantially parallel relation along their lengths. The mesh finish tape, which is a two-component reinforced strand mesh having a width greater than the width of the foundation tape, has openings formed therethrough such that when said two-layer tape is bedded in adhesive covering the joint between adjacent exterior building panels, the adhesive will pass through the plurality of perforations in the polymer composite foundation tape and the openings in the mesh finish tape. The two-layer tape can be incorporated in a two-layer tape core joint treatment system and employed in a method of covering the joint.

In at least some embodiments, a two-layer tape for covering the joint between exterior building panels includes a single, semi-rigid, polymer composite foundation tape, which includes a polymer base having a wall-facing surface to which a floc providing a surface texture may optionally be adhered (or which can alternatively be a smooth texture-free surface) and a tape-facing surface free from floc. The foundation tape has a plurality of perforations formed therethrough. The two-layer tape further includes a flexible, resilient mesh finish tape adhered to the tape-facing surface of the foundation tape in substantially parallel relation. The finish tape has a width greater than the width of the foundation tape, and the mesh finish tape has openings formed therethrough such that when said two-layer tape is bedded in adhesive covering the joint between adjacent exterior building panels, the adhesive passes through the plurality of perforations in the polymer composite foundation tape and openings in the mesh finish tape to secure the two-layer tape to the exterior building panels. The two-layer tape can be incorporated in a two-layer tape core joint treatment system and employed in a method of covering the joint.

The embodiments illustrated and described above are provided as examples of certain preferred embodiments of the present invention. Various changes and modifications can be made to the embodiments presented herein by those skilled in the art without departure from the spirit and scope of this invention, the scope of which shall be limited only by the claims appended hereto.

What is claimed is:

1. A two-layer tape for covering the joint between exterior building panels, the two-layer tape comprising:
a single, semi-rigid, polymer composite foundation tape, wherein:
the foundation tape has a length and a width;
the foundation tape has a plurality of perforations formed therethrough;
a flexible, resilient mesh finish tape adhered to the foundation tape in substantially parallel relation along their lengths, wherein:
the mesh finish tape is a two-component reinforced strand mesh;
the mesh finish tape has a width greater than the width of the foundation tape; and
the mesh finish tape has openings formed therethrough such that when said two-layer tape is bedded in adhesive covering the joint between adjacent exterior building panels, the adhesive will pass through the plurality of perforations in the polymer composite foundation tape and the openings in the mesh finish tape.

2. The two-layer tape of claim 1, wherein the mesh finish tape comprises a vinyl-coated polyester mesh finish tape.

3. The two-layer tape of claim 1, wherein the polymer composite foundation tape includes a polymer base having a wall-facing surface to which a floc providing a surface texture is adhered and a tape-facing surface free from floc.

4. The two-layer tape of claim 1, wherein the polymer composite foundation tape includes a polymer base having a wall-facing surface and a tape-facing surface that are both free from floc.

5. The two-layer tape of claim 1, wherein the mesh finish tape has a thickness of between about 10 and 40 mils.

6. The two-layer tape of claim 1, and further comprising a hot melt material that adheres the polymer composite foundation tape and the mesh finish tape.

7. A system for covering the joint between exterior building panels, comprising:
the two-layer tape of claim 1; and
a bedding layer of the adhesive.

8. The system of claim 7, wherein:
the building panels have beveled edges adjacent the joint that form a niche; and
the system further includes a cover layer of adhesive over the two-layer tape and filling the niche formed by the beveled edges; and
the system includes only two layers of adhesive.

9. The system of claim 7, wherein the adhesive comprises a mastic.

10. A two-layer tape for covering the joint between exterior building panels, the two-layer tape comprising:
a single, semi-rigid, polymer composite foundation tape, wherein:
the polymer composite foundation tape includes a polymer base having a tape-facing surface free from floc and a wall-facing surface;
the foundation tape has a length and a width;
the foundation tape has a plurality of perforations formed therethrough;
a flexible, resilient mesh finish tape adhered to the tape-facing surface of the foundation tape in substantially parallel relation along their lengths, wherein:
the finish tape has a width greater than the width of the foundation tape;
the mesh finish tape has openings formed therethrough such that when said two-layer tape is bedded in adhesive covering the joint between adjacent exterior building panels, the adhesive will pass through the plurality of perforations in the polymer composite foundation tape and the openings in the mesh finish tape to secure the two-layer tape to the exterior building panels.

11. The two-layer tape of claim 10, wherein the polymer composite foundation tape includes a polymer base to which no floc is adhered on either the wall-facing or tape-facing surfaces.

12. The two-layer tape of claim 10, wherein the mesh finish tape comprises a two-component reinforced strand mesh.

13. The two-layer tape of claim 12, wherein the mesh finish tape comprises a vinyl-coated polyester mesh finish tape.

14. The two-layer tape of claim 10, wherein the mesh finish tape has a thickness of between 10 and 40 mils.

15. The two-layer tape of claim 10, and further comprising a hot melt material that adheres the polymer composite foundation tape and the mesh finish tape.

16. A system for covering the joint between exterior building panels, comprising:
the two-layer tape of claim 10; and
a bedding layer of the adhesive.

17. The system of claim 10, wherein:
the building panels have beveled edges adjacent the joint that form a niche; and
the system further includes a cover layer of adhesive over the two-layer tape and filling the niche formed by the beveled edges; and
the system includes only two layers of adhesive.

18. The system of claim 17, wherein the adhesive comprises a mastic.

19. A method for covering the joint between exterior building panels, said method comprising:
applying a bedding layer of adhesive covering the joint; and
bedding in the adhesive a two-layer tape including:
a single, semi-rigid, polymer composite foundation tape, wherein:
the foundation tape has a length and a width;
the foundation tape has a plurality of perforations formed therethrough;
a flexible, resilient mesh finish tape adhered to the foundation tape in substantially parallel relation along their lengths, wherein:
the mesh finish tape is a two-component reinforced strand mesh;
the mesh finish tape has a width greater than the width of the foundation tape; and
the mesh finish tape has openings formed therethrough such that when said two-layer tape is bedded in adhesive covering the joint between adjacent exterior building panels, the adhesive will pass through the plurality of perforations in the polymer composite foundation tape and the openings in the mesh finish tape.

20. The method of claim 19, wherein the mesh finish tape comprises a vinyl-coated polyester mesh finish tape.

21. The method of claim 19, wherein the polymer composite foundation tape includes a polymer base having a tape-facing surface free from floc and a wall-facing surface to which a floc providing a surface texture is adhered.

22. The two-layered tape of claim 19, wherein the polymer composite foundation tape includes a polymer base having a tape-facing surface and a wall-facing surface that are both free from floc.

23. The method of claim 19, wherein the mesh finish tape has a thickness of between about 10 and 40 mils.

24. The method of claim 19, wherein the two-layer tape includes a hot melt material that adheres the polymer composite foundation tape and the mesh finish tape.

25. The method of claim 19, wherein:
the building panels have beveled edges adjacent the joint that form a niche; and
the method further includes applying a cover layer of adhesive over the two-layer tape and filling the niche formed by the beveled edges.

26. The method of claim 19, wherein applying a bedding layer of adhesive comprises applying a bedding layer of mastic.

27. A method for covering the joint between exterior building panels, said method comprising:
applying a bedding layer of adhesive covering the joint; and
bedding in the adhesive a two-layer tape including:
a single, semi-rigid, polymer composite foundation tape, wherein:
the polymer composite foundation tape includes a polymer base having a tape-facing surface free from floc and a wall-facing surface;
the foundation tape has a length and a width;
the foundation tape has a plurality of perforations formed therethrough;
a flexible, resilient mesh finish tape adhered to the tape-facing surface of the foundation tape in substantially parallel relation along their lengths, wherein:
the finish tape has a width greater than the width of the foundation tape;
the mesh finish tape has openings formed therethrough such that when said two-layer tape is bedded in the adhesive covering the joint between adjacent exterior building panels, the adhesive will pass through the plurality of perforations in the polymer composite foundation tape and the openings in the mesh finish tape to secure the two-layer tape to the exterior building panels.

28. The method of claim 27, wherein the mesh finish tape comprises a two-component reinforced strand mesh.

29. The method of claim 27, wherein the mesh finish tape comprises a vinyl-coated polyester mesh finish tape.

30. The method of claim 27, wherein the surface texture is adhered to the wall-facing surface.

31. The method of claim 27, wherein the wall-facing surface is free from floc.

32. The method of claim 27, wherein the mesh finish tape has a thickness of between 10 and 40 mils.

33. The method of claim 27, wherein the two-layer tape further includes a hot melt material that adheres the polymer composite foundation tape and the mesh finish tape.

34. The method of claim 27, wherein:
the building panels have beveled edges adjacent the joint that form a niche; and
the method further applying a cover layer of adhesive over the two-layer tape and filling the niche formed by the beveled edges; and
the method includes applying only two layers of adhesive.

35. The method of claim 27, wherein applying a bedding layer of adhesive comprises applying a bedding layer of mastic.
